(19) United States
(12) Patent Application Publication
(10) Pub. No.: US 2012/0084153 A1
(43) Pub. Date: Apr. 5, 2012

(54) SYSTEM, METHOD, AND COMPUTER-READABLE MEDIUM FOR DISTRIBUTING TARGETED DATA USING ANONYMOUS PROFILES

(75) Inventors: Stéphane Moreau, Beauchamp (FR); Luc Baumelou, Paris (FR)

(73) Assignee: ANNONA CORP S.A., Societe Anonyme, Luxembourg (LU)

(21) Appl. No.: 13/250,549

(22) Filed: Sep. 30, 2011

Related U.S. Application Data
(60) Provisional application No. 61/388,261, filed on Sep. 30, 2010.

(51) Int. Cl. G06Q 30/02

(52) U.S. Cl. 705/14.66

(57) ABSTRACT

Aspects of the invention may involve systems, methods, and computer readable medium. In an embodiment of the invention, a computer-implemented method for targeting messages and advertisements may be provided. The method may include receiving user identification data from a user; retrieving user information based on the user identification data; filtering the user information to create an anonymous profile; ranking messages in a message database using best matching criteria from the anonymous profile to create a ranked list of messages; selecting by the computer, a targeted message from the ranked list of messages; and transmitting, by the computer, the targeted message to the user.

### CROSS-REFERENCE TO RELATED PATENT APPLICATIONS

This application claims priority to U.S. Provisional Patent Application No. 61/388,261 filed Sep. 30, 2010, entitled “System And Method For Distributing Targeted Data Using Anonymous Profiles.” The contents of U.S. Provisional Application No. 61/388,261 are incorporated herein by reference in their entirety.

### SUMMARY

Aspects of the invention may involve systems, methods, and computer readable medium. In an embodiment, a computer-implemented method for targeting messages and advertisements may be provided. The method may include receiving by a computer, user identification data from a user device; retrieving by the computer, user information based on the user identification data; filtering by the computer, the user information to create an anonymous profile; ranking by the computer, messages in a message database using best matching criteria from the anonymous profile to create a ranked list of messages; selecting by the computer, a targeted message from the ranked list of messages; and transmitting, by the computer, the targeted message to the user.

In another embodiment, one or more tangible non-transitory computer-readable storage media for storing computer-executable instructions executable by processing logic may be provided. The media may store one or more instructions for: receiving user identification information from a user; retrieving user information based on the user identification information; creating an anonymous profile by filtering the user information; ranking messages in a message database using best matching criteria from the anonymous profile to create a ranked list of messages; selecting a targeted message from the ranked list of messages; and transmitting the targeted message to the user.

In another embodiment, a computer-implemented system for targeting messages and advertisements may be provided. The system may include a user data storage device for storing data relevant to a user; a processor having memory storing processor-executable instructions; an account management device, wherein the account management device retrieves user information from the user data storage device; an anonymous filter executed on the processor, wherein the anonymous filter communicates with the account management device and filters the user information retrieved from the user storage data device to create an anonymous profile; a message storage device for storing messages for transmission to the user; an anonymous message device, wherein the anonymous message device receives the anonymous profile from the anonymous filter and retrieves a targeted message from the message storage device; and a user interface device for presenting the targeted message to the user, wherein the user interface device receives the targeted message from the anonymous message device.

In another embodiment, a computer-implemented method for targeting messages and advertisements may be provided. The method may include receiving, by a computer, user identification information; retrieving by the computer, user information based on the user identification information; selecting by the computer, a targeted message from a message database; and transmitting the targeted message from the computer.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 depicts an illustrative high-level system diagram for use with an illustrative embodiment for providing targeted data dissemination using anonymous profiles;

FIG. 2 illustrates an example processing flow for use with an illustrative embodiment for providing targeted data dissemination using anonymous profiles;

FIG. 3 illustrates an example authorization query for use with an illustrative embodiment for providing targeted data dissemination using anonymous profiles;

FIG. 4 depicts an illustrative anonymous filter for use with an illustrative embodiment for providing targeted data dissemination using anonymous profiles;

FIG. 5 illustrates an example message server request for use with an illustrative embodiment for providing targeted data dissemination using anonymous profiles;

FIG. 6 illustrates an example workflow for use with an illustrative embodiment for providing targeted data dissemination using anonymous profiles; and

FIG. 7 depicts an example computer system that may be used in implementing an illustrative embodiment.

### DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without departing from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples.

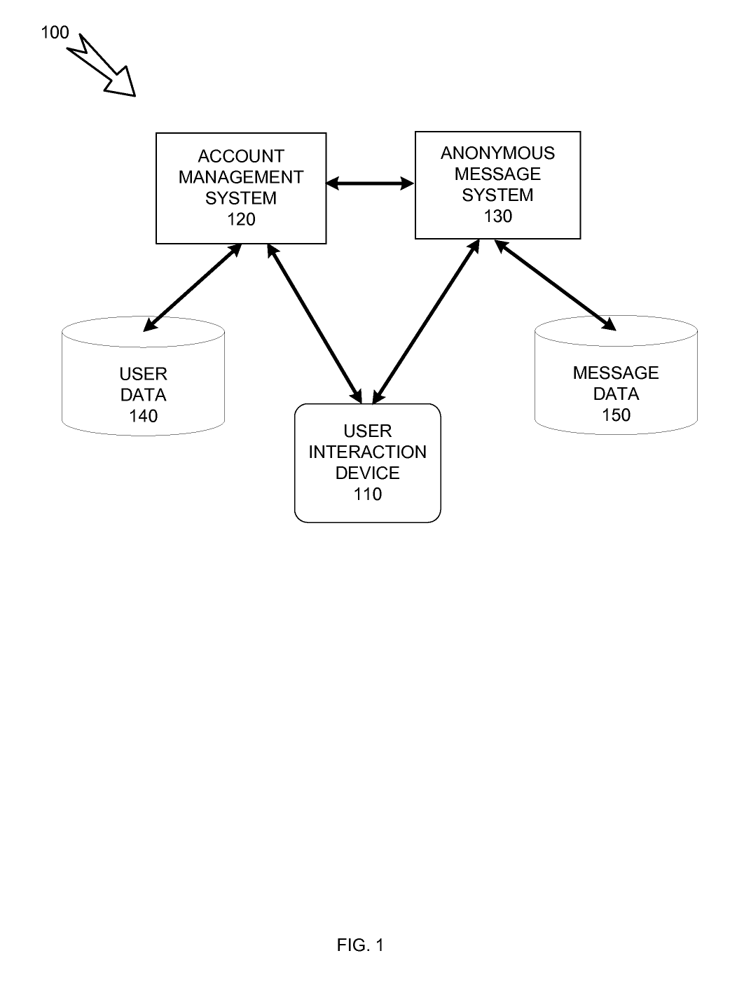

FIG. 1 depicts illustrative high-level system 100 for use with an illustrative embodiment for providing targeted data dissemination using anonymous profiles. System 100 may include user interaction device 110, account management system 120, anonymous message system 130, user data 140, and message data 150. In an embodiment, the system may use anonymous profiles (e.g., a profile where user identifying information or personal data has been removed) or non-anonymous profiles.

User interaction device 110, may include a device that allows a person to interact with a machine or a network of machines. User interaction device 110 may include, for example, a parking meter, a transport ticket dispenser, a telephone, an internet terminal, an automated teller machine (e.g., ATM/ABM Bank), an electronic payment terminal (EPT), a cash dispenser, an access control system, a payment processing system, a tablet PC, a computer, a mobile device, an iPad, a mobile phone, etc. The present application, however, is not meant to be limited to only the listed devices. User interaction device 110 may communicate with account management system 120 and/or anonymous message system 130.

Account management system 120, may include a computer or a network of computers that may manage a plurality of accounts. The accounts may be user or customer accounts that may contain sensitive or private information such as name, home address, work address, social security number, medical history, etc. User or customer data may be stored in user data 140.

User data 140 may be stored in a database or other storage that may be accessible by account management system 120. In one embodiment, due to the possible private or privileged nature of the contents of user data 140, account management system 120 may be the only system authorized to access user data 140. Account management system 120, may communicate with user interaction device 110 and/or anonymous message system 130.

Anonymous message system 130 may include a computer or a network of computers that may select messages or advertisements from a collection of message data 150. Message data 150 may be a collection of messages or advertisements which may be stored in a database or other storage. Anonymous message system 130 may be part of account management system 120 or they may be separate. In an embodiment, anonymous message system 130 and account management system 120 may be a separate entity, separately owned, separately controlled, and/or separately managed. In another embodiment, anonymous message system 130 and account management system 120 may jointly owned, jointly controlled, and/or jointly managed.

Data, stored in message data 150, such as advertising messages, may be distributed to targeted individuals by using anonymous profiles. Account management system 120, may be run or controlled by, for example, banks, financial institutions, mortgage companies, reward programs, airlines, credit card companies, government institutions, hospitals, medical offices, or other systems containing personal or sensitive data. Account management system 120 may contain information useful for identifying individuals who may be responsive to a targeted message. Certain existing personal data of a user, for example, may be known only by account management system 120. The information contained in the account management systems 120 may be filtered to produce an anonymous profile. The anonymous profile may then be used to select a targeted message or advertisement. The message or advertisement may correspond to a set targeting criteria when a transaction, for example, takes place.

Targeting criteria may include characteristics which may be used to select a best matching advertisement or message for a specific class of user. For example, criteria may include gender, age, marital status, social class, average income, and/or any additional non-personal information. Certain identifying information (e.g., name, home address, work address, social security number, government identifier, etc.) or private characteristics (payments to health care providers, medical history, medical purchases, etc.) existing in an account management system which may lead to a privacy concern may not be extracted. The various criteria extracted or filtered may vary based on the purpose and data handled as well as the purpose of the account management system 120.

During, for example, a financial transaction (e.g., a withdrawal, deposit, ATM usage, cash dispenser, or an account inquiry with an online bank) or other transaction (e.g., parking, restaurant, transport ticket dispenser, telephone or internet operators, access control system, payment processing system, etc.) using user interaction device 110 and/or an account management system 120, the user may be accurately identified and authenticated. Such identification and authentication may be performed by account management system 120 using, for example, user data 140, which may contain information on, for example, customers, patients, subscribers, etc. User data 140 may contain specific information about the user and this information may be filtered to create an anonymous generic profile about this user. An anonymous profile may contain, for example, age, sex, income, social status, etc.

Once the user has been identified, a generic profile of a user may be created by filtering out identifying information of the user from data stored in user data 140. Excluded identifying information may include, for example, name, address, phone number, etc. The extracted generic profile may be used during the transaction process to request from anonymous message system 130, a message or advertisement corresponding to the criteria of this generic anonymous profile. A user targeted message or advertisement may be retrieved from message data 150 without the need for any specific knowledge about the targeted user or the identity of the targeted user. Messages or advertisements stored in message data 150 may have an associated criteria. The criteria may be established by, for example, the advertiser to associate the message with targeted advertisments.

A passive selection method of messages or advertisements through the use of an anonymous dynamic profile may be implemented on many types of networks (e.g., wired or wireless), on many types of user interaction devices 110 such as, terminals and devices (e.g., fixed, mobile, or highly mobile) and may manage many types of messages (e.g., text, audio, video, multimedia, etc.) in a targeted, time- and content-relevant manner.

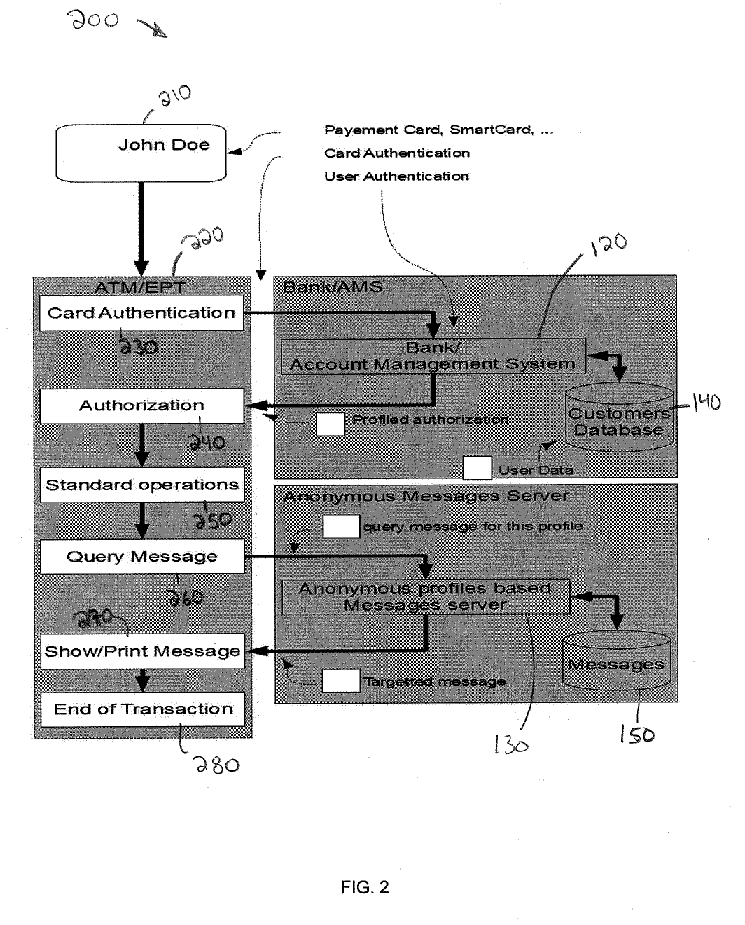

FIG. 2 illustrates an example processing flow 200 for use with an illustrative embodiment for providing targeted data dissemination using anonymous profiles. Example processing flow 200 may include user 210, ATM/EPT 220, and a series of steps 230-280.

User 210 may arrive at ATM/EPT 220. ATM/EPT 220 may be a form of user interaction device 110. User 210 may provide (e.g., insert, swipe, etc.) a bank/credit card (e.g., a financial card), for example, for identification. In step 230, the validity of the card may be checked. After checking the validity of the card in step 230, ATM/EPT 220 may then move to step 240 and seek authentication of user 210 by, for example, asking for a personal identification number (PIN) code (depending of the country/technology used). The identifying and authenticating data may then be used by ATM/EPT 220 to request the bank, based on communications with account management system 120 and to authorize the transaction requested by user 210. Other identification may include fingerprint, retina scan, social security number, key fob, security token, software token, key, etc.

Concurrently or after authentication 240, account management system 120, at a bank, for example, may access user data 140 and may select information corresponding to the identified and authenticated user 210. The selected information may contain relevant information about the user, for example, name, sex, date of birth, marital status, address, profession, etc. The information may also include a profile, for example, social class, buying habits, life style, etc. Or, a profile may be created from the existing data.

Account management system 120 may respond to ATM/EPT 220, for example, to provide settlement authorization. Once user 210 is authorized in step 240, step 250 may proceed with standard operations (e.g., account withdrawal, account status, etc.).

In one embodiment, account management system 120 may add to its response, for example, a subset of information about the user. The subset of information may be filtered to prevent the identification of the user, but may give valuable anonymous information for the purpose of profiling the user. The subset of information may include, for example but not limited to, information regarding gender, age, year of birth, marital status, social class, range of average income, etc.

Thus, when ATM/EPT 220 receives from account management system 120 the transaction authorization, ATM/EPT 220 may also receive the filtered anonymous information. In an embodiment, a dedicated request may be used to request the filtered anonymous information. In step 260, ATM/EPT 220 may request from anonymous message system 130 the message or advertisement that may best correspond to a profile created by the filtered anonymous information. Account management system 120, user interaction device 110, and/or ATM/EPT 220 may make the request to the anonymous message system 130, depending on the topology, organization and performance needs.

Anonymous message system 130 may be a standard data server that contains a set of pre-formatted advertising messages awaiting requests from account management system 120, user interaction device 110, and/or ATM/EPT 220. Anonymous message system 130 may be located in user interaction device 110, in the account management system 120, in the ATM/EPT 220, and/or externally.

An exemplary request sent to anonymous message system 130, in step 260, may be: “Select a message matching criteria: Male, married, born in 1964, UMC (“Upper Middle Class”), average income from $3000 to $4000.” This definition of an average income may be defined by week, month, or year without any impact on the result, provided it is handled on a same basis for the whole model. In one embodiment, dealing with multiple currencies may be done by converting them dynamically to a “standard” (e.g., Euros, U.S. dollars, etc.) across the model. Anonymous message system 130 may then accesses message data 150 and select the message that best matches the profiling criteria, or a message by default if the criteria does not define a particular message. Anonymous message system 130 may then send the selected message to user interaction device 110 for display or printing in step 270.

The messages managed by the message server may be categorized into various classes and families. For example, global messages may be designed to be visible without geographical criterion (e.g., ads without text, very well identified logos, corporate messages etc. such as Coca-Cola®, Google®, Apple®, etc.); national messages may be designed to be visible within a country; regional messages may be designed to be visible within a region as part of a country, and defined as a country (or state) code and or a generic postal code (e.g., region may be identified by using the first two characters of the postal code); and local messages may be designed to be visible within a specific geographic area, part of a country and defined as a country (or state) code and/or the generic postal ZIP code, for example.

To manage geographic criteria, each user interaction device 110 may inform the message server of its location. It may calculate current location by using, for example, the postal code where it is installed; a unique ID code, allowing an internal database of the message server to recognize and localize this terminal; using global positioning satellite (GPS) information, and/or by using TCP/IP protocol, the originating IP address of the request could be used using GeoLocalization methods to find the location of the terminal, in the case of a fixed address.

In step 270, the advertisement or message may be audibly presented through, for example, a speaker system and/or shown to user 210 on, for example, a display screen. Alternatively, advertisement or message may be printed out in any accompanying paper receipt for user 210. In another embodiment, a Braille reader may be used to communicate with the user. The transaction may end in step 280.

In an embodiment, user interaction device 110 may expose additional data, such as a “Merchant Category Code” (MCC) of the vendor and/or a shop-keeping unit code (SKU) of selected items, allowing the message server to recognize the category of goods or services covered or purchased by a specific user interaction device 110 and use it as an additional criteria.

According to an exemplary embodiment of the present application, several families of messages may be available. Non-targeted messages, for example, may be intended to be published regardless of the profile of the user 210. Non-targeted messages may be generic. Non-targeted messages may be designed for users of a given bank or banking group. Examples of non-targeted messages include all users in a given country, clients of a specific user interactive device 110 or in a particular geographic location, etc.

Targeted Messages, on the other hand, may be intended to be distributed only in the case of a match, or close match within a predetermined range, with one or more criterion of the anonymous profile received from user interaction device 110.

Messages may also belong to a particular account management system 120 (e.g., a bank or banking group or a specific selection of banks, companies or brand names). This categorization may allow filtering advertising messages that may be specific to a particular account management system 120, without interfering with a different account management system 120. It may also allow integration of certain rules of “censorship” specific to the request of a particular account management system 120 regarding the messages it may wish to offer. For example, a large group or company may wish to present multiple brand names but exclude competitors. The bands may be selected because they may be non-competitive and not create any adverse interaction while being advertised on the large group or company's terminal network. The same large group or company may disallow any advertisement from, for example, a direct competitor on the terminal network. Or, for example, advertisements may be excluded because of differing moral or corporate values. This filtering functionality may, for example, allow filtering out particular banks from a specific ATM network. For example, when a request for a message comes from a bank of the group “A”, no ads of a bank of the group “B” may be returned until explicitly allowed.

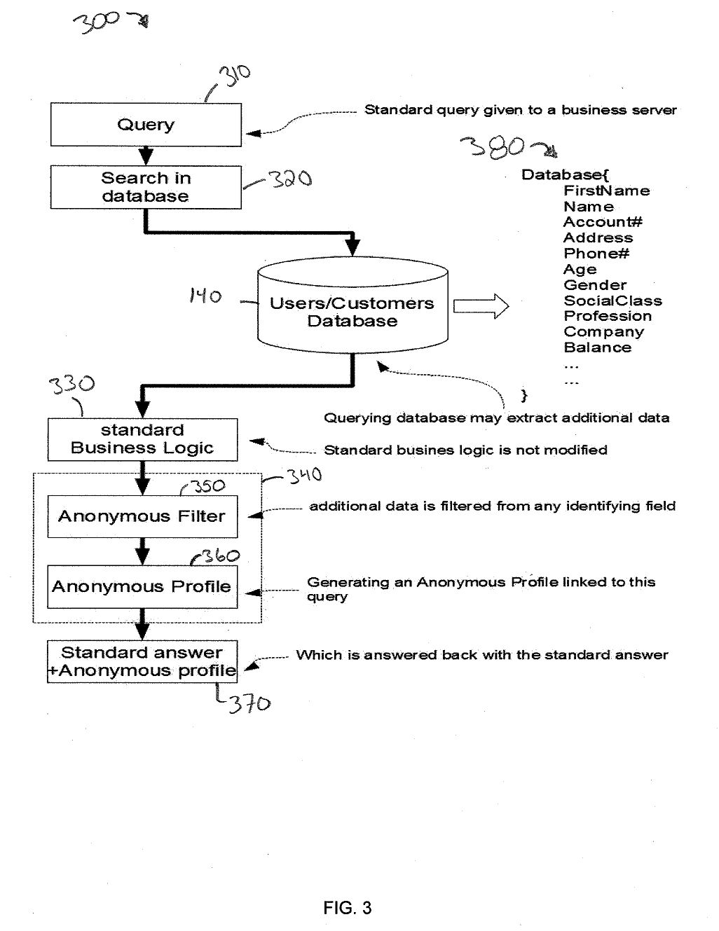

FIG. 3 illustrates an example authorization query 300 for use with an illustrative embodiment for providing targeted data dissemination using anonymous profiles. A query 310 may be received by account management system 120 (e.g., bank, parking, service provider, subscription provider, etc.). The query 310 may be sent from a user interaction device 110, for example. The query 310 may be, for example, a request whether the transaction is authorized. Account management system 120 may accesses user data 140 (e.g., customer databases) and perform a search 320 to verify the authenticity of the transaction. User data 140 may contain information such as shown in database entry 380, for example, but not limited to, first name, last name, middle name, name suffix, name prefix, account number, home address, work address, home phone, work phone, mobile phone, birth date, age, gender, social class, profession, company, education, balance, highest balance, average balance, etc.

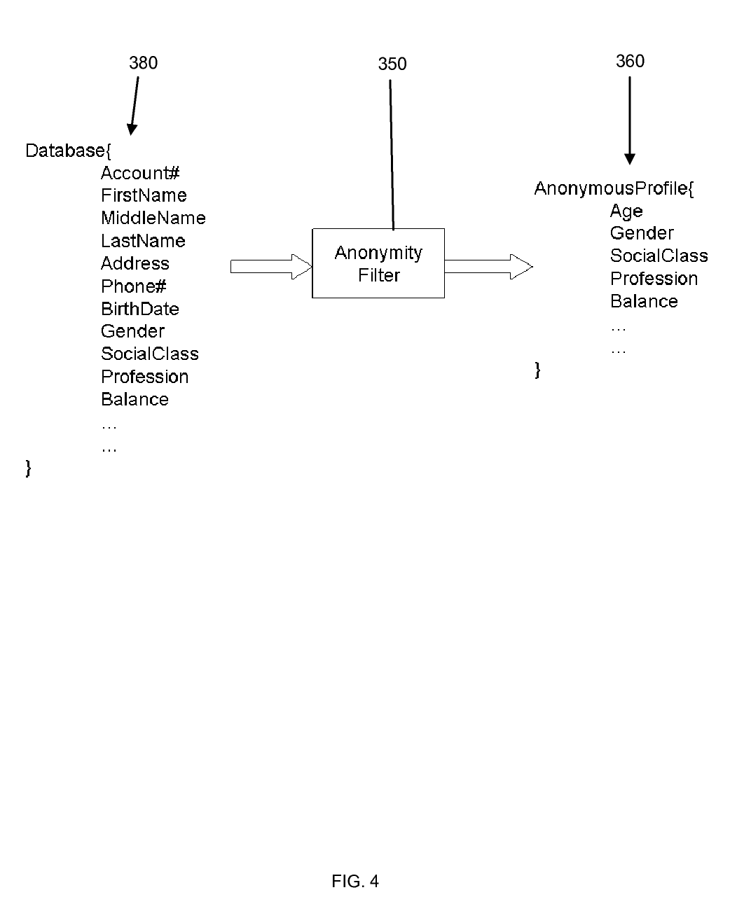

FIG. 4 depicts an illustrative anonymous filter for use with an illustrative embodiment for providing targeted data dissemination using anonymous profiles. FIG. 4 shows how select values in complete database entry 380 may be extracted by anonymous filter 350 and may produce an anonymous profile 360. Anonymous profile 360 may be a subset of the values from database entry 380. Anonymous filter 350 may also produce anonymous profile 360 using data from database entry 380. For example, anonymous filter 350 may determine a social class of the user based on the income and/or the spending habits of the user.

Moving back to FIG. 3, query 310 may extract a yes/no-type Boolean answer validating or not validating the transaction. In addition to standard business logic 330, account management system 120 may also extract profile information 340 by filtering any personal or identifying information. Anonymous filter 350 may filter any personal or identifying data. Anonymous profile 360 may create a user profile for user 210 that may be linked to query 310. Exemplary anonymous information that may be extracted and used may include, but not limited to, for example, gender (e.g., male/female), marital status (e.g., single, married, divorced, widowed), year of birth (to calculate an approximate age), social class (e.g., socio professional conditions), range of average income by a static base time (e.g., monthly, yearly, weekly, etc.) for the whole process (e.g., in increments of $1000), and any additional non-personal information which may be used to profile customer/user 210.

In one embodiment, in a secure environment and/or where privacy may not be a concern, the filtering process may not be anonymous. For example, a bank in its own ATM network may choose to expose the name of its customers while they use these ATM. In an embodiment, account management system 120 and anonymous message system 130 may be controlled by the same entity and can maintain and guarantee user privacy.

In 370, the standard answer and anonymous profile 360 may be sent back to user interaction device 110. The account management system 120 may send the anonymous profile 360 back to user interaction device 110 before, concurrently with, or after the standard answer (e.g., user authorization).

According to an exemplary embodiment, anonymous message system 130 may be implemented directly into the account management system 120, and/or in the user interaction device 110 (e.g., terminal). Such a combination may enable merging queries and/or pre-loading of the messages or advertisements locally accordingly to optimize latencies, bandwidth and time needed for the whole process.

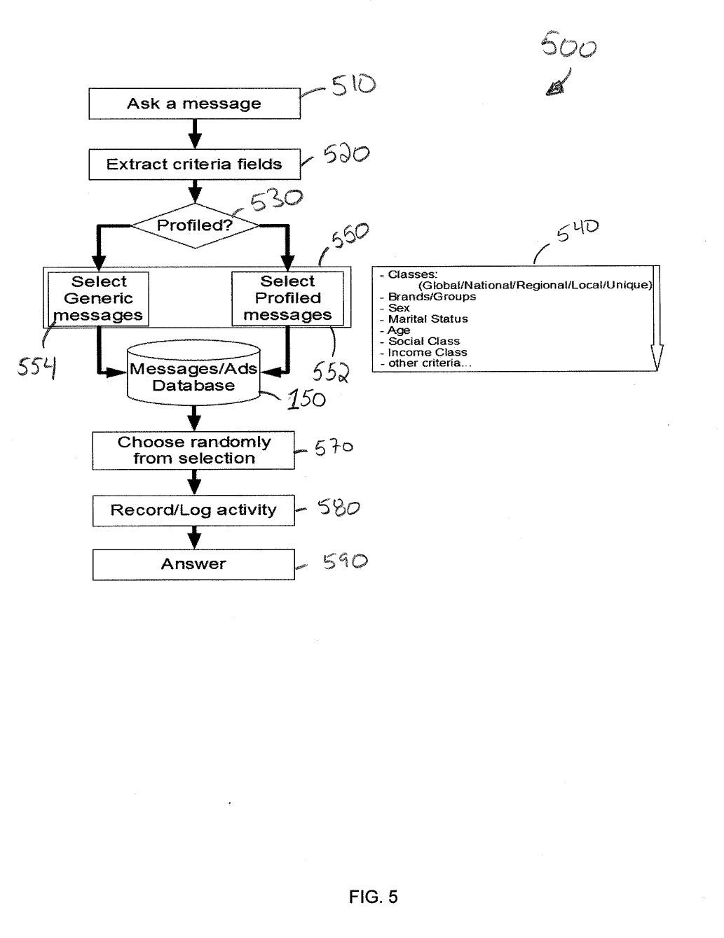

FIG. 5 illustrates example message server request 500 for use with an illustrative embodiment for providing targeted data dissemination using anonymous profiles.

When user interaction device 110 receives autonomous profile 360 and the authorization to proceed with the transaction, the user interaction device 110 may then send a request to anonymous message system 130 to get the message or advertisement best matching the criteria (e.g., anonymous profile 360). Alternatively, if the user interaction device 110 receives anonymous profile 360, but authorization to proceed with the transaction is denied, the user interaction device 110 may still send a request to anonymous message system 130 for a message or advertisement best matching the supplied criteria (e.g., anonymous profile 360). Anonymous message system 130 may receive this request in step 510 for a message from user interaction device 110.

User interaction device 110 may send to anonymous message system 130 a request with the criteria along with optionally its own identifier or postal code in order to geographically localize itself (or any other information allowing, for example, identification, localization, group recognition, etc.). The user interaction device 110 may proceed, in parallel, with handling the necessary steps to process the user 210 requested transaction.

Anonymous message system 130 may receive a request from user interaction device 110 and may extract in step 520 the different criteria contained in this request. Based on the anonymous profile 360, anonymous message system 130 may select in step 550 the most appropriate message or advertisement from message data 150. Anonymous message system 130 may determine whether the user is profiled in step 530 (e.g., whether the user should receive a targeted message). If the user is to be profiled, then anonymous message system 130 may select profiled messages in step 552 from message data 150. Alternatively, anonymous message system 130 may select generic messages in step 554 from message data 150.

Extracted values 540 may include sample properties extracted from account management system 120. Extracted values 540 may be filtered out or derived from any personal information and may lead to an anonymous profile which may define the criteria used to select a message or an advertisement. Extracted values 540 may be an example of the kind of data which may be used for criterion. Different account management systems 120 may contain different data with different fields. For example, an employee database may not contain the same fields as a parking/TV subscription system. Extraction step 520 may lead to extracted values 540 which may lead to criterion in the messages to select.

In an exemplary embodiment, anonymous message system 130 may analyze available messages within message data 150 or collection of messages (e.g., the collection of messages may define the “database” of messages and/or advertisements to select from given criteria) and make a selection based on one or more of the following criteria, for example. A first step may be to query whether the message is valid (e.g., start date reached, expiry date unexpired, etc.).

Messages may be selected from the following example types of groups. Global messages, for example, may be selected automatically. National messages, for example, may be selected if the geographic code of the user interaction device 110 corresponds to the country of this message. Regional messages, for example, may be selected if the geographic code of the user interaction device 110 corresponds to the country, state (if available) and the first two digits of the postal code of the message (or other location identifier). Local messages, for example, may be selected if the geographic code of the user interaction device 110 corresponds to the country, state (if available) and the complete postcode of this message (or other location identifier).

Some messages may correspond to an allocation of the user interaction device 110 (e.g., this terminal is part of the group selected for this message). For these messages, if the message is not-targeted, the selection criterion may stop here and the message may be selected. For example, where the message is non-targeted, no additional criterion needs to be evaluated. A not-targeted message may be a message that does not use the anonymous profile.

If the message is targeted, then the following example selection criteria may be utilized. Messages in message data 150 may be examined. If anonymous profile 360 has specified a sex, the indicated sex may be verified with the message. If the sex does not match, then the message may not be used and/or a score of zero may be attributed to the message. If anonymous profile 360 has specified a marital status, the marital status may be verified with the message. If the marital status does not match, the message may not be used and/or a score of zero may be attributed to the message. If anonymous profile 360 has specified an age, the indicated age may be verified with the message. A message may specify a range of ages, such as two values: a minimum and a maximum, called a “composite value.” A minimum age, if specified, may include all ages equal to or higher than this value qualifies (e.g., value “from . . . ”). A maximum age, if specified, may include all ages equal to or lower than this value qualifies (e.g., value “until . . . ”). If both minimum and maximum values are specified by the message, all ages included between the two values may qualify. If the age does not match between anonymous profile 360 and the message, the message may not be used and/or a score of zero may be attributed to the message. If anonymous profile 360 has specified a social class, the social class may be verified with the message in the form of a composite value (see age calculation). If the social class does not match between anonymous profile 360 and message, the message may not be used and/or a score of zero may be attributed to the message. If anonymous profile 360 has specified a level of income, the level of income may be verified with the message in the form of a composite value (see age calculation). If the level of income does not match between anonymous profile 360 and message, the message may not be used and/or a score of zero may be attributed to the message. In an embodiment, the score may vary depending on the distance away from the desired age, social class, income level, etc.

In an exemplary embodiment, for each available message available to anonymous message system 130, a message may be selected and the message's default criteria. A message's default criteria may define the message. A message's default criteria may be defined, for example, as “Local,” limited for the ZIP code 92010, user's gender “MALE,” above 45 years old, etc. Those specific characteristics defining its default criteria which will used to verify any matching an anonymous profile may be compared against those from anonymous profile 360 (e.g., a customer's profile). In an embodiment, a message may have more than one default criteria.

When there is a match between the criteria and anonymous profile 360, a specific score (which may have a default value of, for example, “1”) may be added to the global score of this message. After comparing messages available against available profile criteria, this list of scored messages may be sorted in a descending order by their score. The two first scores, for example, may be checked to verify at least two different messages, for example, obtained the same highest score. If multiple messages receive the same highest score, one message may be randomly selected 570 from this selection. One possible method of choosing a message between two or more messages with the highest score may be to use a random number between 1 and the total number of messages of this specific highest score, for example.

Where one message may have received the highest score, it may be selected as the best matching message for those criteria. This method may be implemented as a hierarchic tree of sub-queries (e.g., nested “SELECT” queries in the SQL language), and/or as a direct two dimension array of messages and their corresponding score, explored in only one pass in any generic computing language (e.g., Java, C/C++, C#, Pearl, .NET, etc.), as well as any string matching algorithm or pattern matching algorithm, for example. Modeling the default score given to a specific criterion by giving a different value than “1” for one or many criteria, may allow modulating the weight and priority of some criteria against others. In this case, criteria with a lower score but higher weight may be given priority over criteria with a higher score but lower weight. For example, the gender criterion may receive a default score of “2” while the age criterion receives a default score of “3.” The process may prioritize some selection using a chosen precedence, for specific criteria among others. This may allow defining one or more criteria using different scores, for example, considering “Age” adding a score of 3, and “Gender” adding a score of 2, these two specific criteria will became more important than other criteria with lower scores for generating the global score of a message in front of others, and the final selection will reflect a kind of priority of the Age criterion before Gender, then the other lower scored criteria to select any message.

Anonymous message system 130 may obtain a list of weighted messages corresponding to the criteria defined by the request. Anonymous message system 130, may sort the list based on weight. If more than one message has the highest weight, then anonymous message system 130, may randomly select one of the messages with the highest weight. This selected message may be one of the best messages that matches the criteria given, while incorporating a random factor to provide equal opportunity to all messages whose criteria may be equally qualified in statistical terms.

Anonymous message system 130, may send the selected message to the user interaction device 110 and may record the message selection within its internal management system. This may allow keeping track of the numbers of times a message was selected and viewed. Analysis may be performed to detect a possible correlation between received criteria and messages selected as well as geographical and time distribution of messages, etc. This kind of analysis may provide a real and qualified feedback, as well as additional information about the accuracy of an advertisement campaign (e.g, exposing timings, geographical zones, tendencies, linked criteria not used for targeting, etc.) Such feedback may assist in refining the criteria used, refining the campaign/message itself or calculating aggregate statistics about the effectiveness of the campaign. Additionally, detailed records may be kept for billing information for the announcers using this system, for example.

The user interaction device 110 may receive a message confirmed by anonymous message system 130 to best match the profile of the authenticated user without disclosing any information that would allow identification of the user by anonymous message system 130.

In an embodiment, no personal information may be exposed outside the account management system 120.

The user interaction device 110 may display the message, or prints it on the ticket or receipt for the attention of the user 210. The message may be displayed using the screen of user interaction device 110 and/or ATM/EPT 220. In other embodiments, the message may be transmitted audibly via a speaker system attached to user interaction device 110 and/or ATM/EPT 220. In another embodiment, the message may be presented to a user via a touch device (e.g., a Braille display) attached to user interaction device 110 and/or ATM/EPT 220.

In an alternative embodiment of the present application, during periods of inactivity or during the time required to identify/authenticate the user, user interaction device 110 may send a request to anonymous message system 130 and receive and display non-profiled messages or such messages based on generic criteria like geographical location, allocation factors corresponding to the group who owns the user interaction device 110 or country or state, nature of the user interaction device 110, category of the company operating the user interaction device 110, time of the day, time zone, local events, etc.

This operating mode may be used on a regular and automatic basis after a given timeout and inactivity. This may allow the user interaction device 110 to be used as a simple additional passive media display with a reduced usage of its targeting and profiling capabilities. Although, some targeting may occur with the use of regional or local messages.

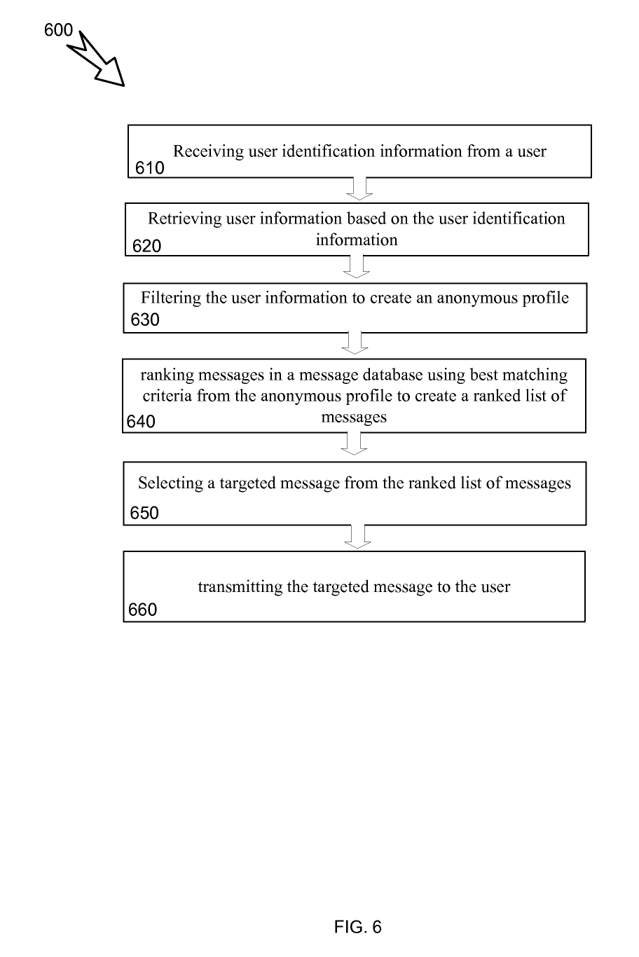

FIG. 6 illustrates an example workflow 600 for use with an illustrative embodiment for providing targeted data dissemination using anonymous profiles. Flow may begin at step 610. In step 610, user identification information may be received from a user. From 610 flow may move to 620.

In step 620, user information may be retrieved based on the user identification information. User information may be retrieved, for example, by account management system 120 from user data 140. From 620 flow may move to 630.

In step 630, user information may be filtered to create an anonymous profile 360. The anonymous profile may be created by, for example, anonymous filter 350. From 630 flow may move to 640.

In step 640, the messages in the message database may be ranked using best matching criteria from the anonymous profile 360 to create a ranked list of messages. This step may compare the messages to anonymous profile 360 and rank the messages based on the comparison. From 640 flow may move to 650.

In step 650, a targeted message may be selected from the ranked list of messages. From 650 flow may move to 660.

In step 660, the selected targeted message may be transmitted to the user. From 660 flow may end.

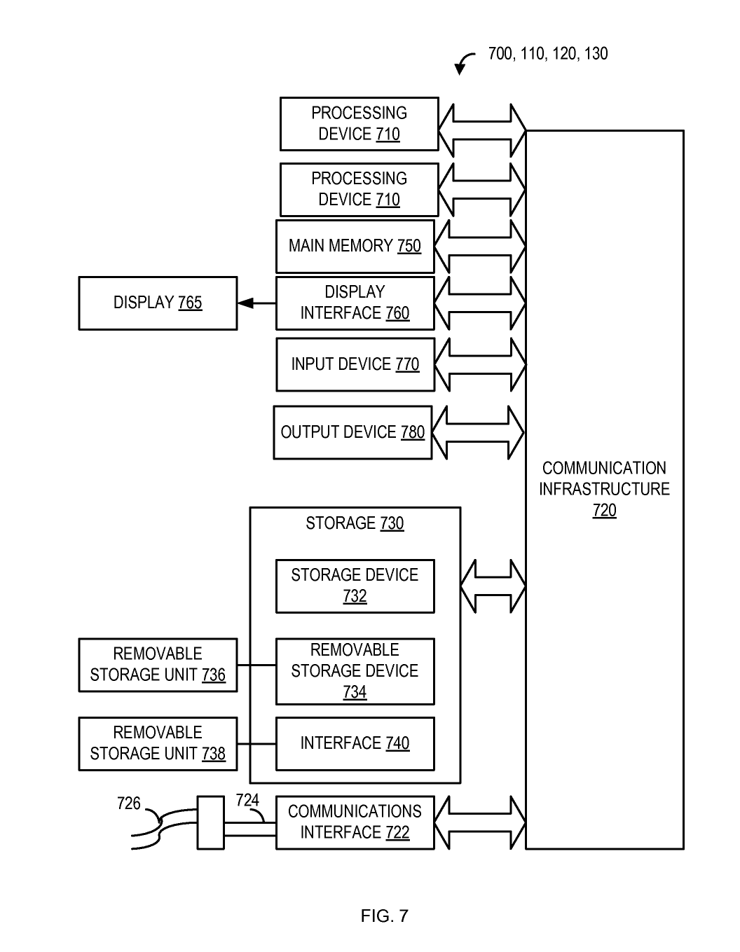

FIG. 7 depicts an illustrative computer system that may be used in implementing an illustrative embodiment of the present invention. Specifically, FIG. 7 depicts an illustrative embodiment of a computer system 700 that may be used in computing devices such as, e.g., but not limited to, standalone or client or server devices. FIG. 7 may also depict user interaction device 110, account management system 120, anonymous message system 130, and/or ATM/EPT 220.

FIG. 7 depicts an illustrative embodiment of a computer system that may be used as client device, or a server device, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of computer system 700 is shown in FIG. 7, depicting an illustrative embodiment of a block diagram of an illustrative computer system useful for implementing the present invention. Specifically, FIG. 7 illustrates an example computer 700, which in an illustrative embodiment may be, e.g., (but not limited to) a personal computer (PC) system running an operating system such as, e.g., (but not limited to) MICROSOFT® WINDOWS° NT/98/2000/XP/Vista/Windows 7/etc. available from MICROSOFT® Corporation of Redmond, Wash., U.S.A. or an Apple computer executing MAC® OS from Apple® of Cupertine, Calif., U.S.A. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 700 is shown in FIG. 7. Other components of the invention, such as, e.g., (but not limited to) a computing device, a communications device, an automated teller machine, a point of sale device, a telephone, a personal digital assistant (PDA), an iPhone™, an iPad™, a 3G wireless device, a wireless device, a personal computer (PC), a handheld PC, a laptop computer, a smart phone, a mobile device, a netbook, a handheld device, a portable device, a parking meter, an ATM, an EPT, a ticket dispenser, a cash dispenser, an access control system, a payment processing system, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 7. In an illustrative embodiment, services may be provided on demand using, e.g., an interactive television device (iTV), a video on demand system (VOD), via a digital video recorder (DVR), and/or other on demand viewing system.

Computer system 700 may include one or more processors, such as, e.g., but not limited to, processing device 710. Processing device 710 may be connected to communication infrastructure 720 (e.g., but not limited to, a communications bus, cross-over bar, interconnect, or network, etc.). Processing device 710 may include any type of processor, microprocessor, or processing logic that may interpret and execute instructions (e.g., for example, a field programmable gate array (FPGA)). Processing device 710 may comprise a single device (e.g., for example, a single core) and/or a group of devices (e.g., multi-core). Processing device 710 may include logic configured to execute computer-executable instructions configured to implement one or more embodiments. The instructions may reside in main memory 750 or storage 730. Processing device 710 may also include multiple independent cores, such as a dual-core processor or a multi-core processor. Processing device 710 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement an embodiment of the invention using other computer systems and/or architectures.

Computer system 700 may include display interface 760 that may forward, e.g., but not limited to, graphics, text, and other data, etc., from the communication infrastructure 720 (or from a frame buffer, etc., not shown) for display on the display unit 765. The display unit 765 may be, for example, a television, a computer monitor, an LCD, or a mobile phone screen. The output may also be provided as sound through a speaker.

The computer system 700 may also include, e.g., but is not limited to, main memory 750, random access memory (RAM), and storage 730, etc. Main memory 750, random access memory (RAM), and storage 730, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

Storage 730 may include, for example, (but is not limited to) hard disk drive 732 and/or removable storage drive 734, representing a floppy diskette drive, a magnetic tape drive, an optical disk drive, a compact disk drive CD-ROM, flash memory, etc. Removable storage drive 734 may, e.g., but is not limited to, read from and/or write to a removable storage unit 736 in a well known manner. Removable storage unit 736, also called a program storage device or a computer program product, may represent, e.g., but is not limited to, a floppy disk, magnetic tape, optical disk, compact disk, etc. which may be read from and written to removable storage drive 734. As will be appreciated, the removable storage unit 736 may include a computer usable storage medium having stored therein computer software and/or data.

In alternative illustrative embodiments, storage 730 may include other similar devices for allowing computer programs or other instructions to be loaded into computer system 700. Such devices may include, for example, removable storage unit 738 and interface 740. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM)) and associated socket, and other removable storage units 738 and interfaces 740, which may allow software and data to be transferred from removable storage unit 738 to computer system 700.

Computer 700 may also include input device 770. Input device 770 may include any mechanism or combination of mechanisms that may permit information to be input into computer system 700 from, e.g., a user. Input device 770 may include logic configured to receive information for computer system 700 from, e.g. a user. Examples of input device 770 may include, e.g., but not limited to, a mouse, pen-based pointing device, or other pointing device such as a digitizer, a touch sensitive display device, and/or a keyboard, other data entry device, a biometric input device, a video source, an audio source, a microphone, a web cam, a video camera, and/or other camera (none of which are labeled).

Computer 700 may also include output device 780 which may include any mechanism or combination of mechanisms that may output information from computer system 700. Output device 780 may include logic configured to output information from computer system 700. Embodiments of output device 780 may include, e.g., but not limited to, display 765, and display interface 760, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 700 may include input/output (I/O) devices such as, e.g., (but not limited to) communications interface 722, cable 726 and communications path 724, etc. These devices may include, e.g., but are not limited to, a network interface card, and/or modems.

Communications interface 722 may allow software and data to be transferred between computer system 700 and external devices.

In this document, the terms “computer program medium” and “computer readable medium” may be used to generally refer to media such as, e.g., but not limited to, removable storage drive 734, a hard disk installed in hard disk drive 732, flash memories, removable discs, non-removable discs, etc. In addition, it should be noted that various electromagnetic radiation, such as wireless communication, electrical communication carried over an electrically conductive wire (e.g., but not limited to twisted pair, CAT5, etc.) or an optical medium (e.g., but not limited to, optical fiber) and the like may be encoded to carry computer-executable instructions and/or computer data that may perform embodiments of the invention on e.g., a communication network. These computer program products may provide software to computer system 700. It should be noted that a computer-readable medium that comprises computer-executable instructions for execution in a processor may be configured to store various embodiments of the present invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, or as a mobile application

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents.

What is claimed is:

1. A computer-implemented method for targeting messages and advertisements comprising:
receiving by a computer, user identification data from a user device;
retrieving by the computer, user information based on the user identification data;
filtering by the computer, the user information to create an anonymous profile;
ranking by the computer, messages in a message database using best matching criteria from the anonymous profile to create a ranked list of messages;
selecting by the computer, a targeted message from the ranked list of messages; and
transmitting, by the computer, the targeted message to the user.

2. The method of claim 1, wherein the anonymous profile comprises at least one of:
user age, user birth date, user year of birth, user gender, user income revenue, user average income, user location, user marital status, user social class, or user level of education.

3. The method of claim 1, wherein the anonymous profile does not contain sensitive, personal, or nominative information on the user.

4. The method of claim 1, wherein the targeted message is one of:
an advertisement, a global message, a national message, a regional message, or a local message.

5. The method of claim 1, further comprising:
receiving purchase information, wherein purchase information includes one of a merchant category code or a stock-keeping unit code.

6. The method of claim 5, further comprising:
ranking the ranked list of messages based on the purchase information.

7. The method of claim 2, wherein the user location is determined based on at least one of:
a postal code, a unique identifier, global positioning satellite (GPS) information, geolocalization techniques.

8. The method of claim 1, wherein the ranking is calculated based on assigning weights to fields in the anonymous profile.

9. The method of claim 1, further comprising: recording the selected message was transmitted.

10. The method of claim 1, further comprising:
determining if more than one message is ranked highest in the ranked list of messages, wherein if more than one message is ranked highest in the ranked list of messages then randomly selecting the targeted message from one of the more than one message ranked highest in the ranked list.

11. The method of claim 1, wherein the user device comprises one of:
a parking meter, a transport ticket dispenser, a telephone, an internet terminal, an automated teller machine, an electronic payment terminal, a cash dispenser, an access control system, a payment processing system, a tablet PC, a computer, a mobile device, or a mobile phone.

12. The method of claim 1, where in the user identification data comprises at least one of:
a user name, a personal identification number (PIN), data from a financial card, a fingerprint, a retina scan, a social security number, a key fob, a security token, a software token, or a key.

13. One or more tangible non-transitory computer-readable storage media for storing computer-executable instructions executable by processing logic, the media storing one or more instructions for:
receiving user identification information from a user;
retrieving user information based on the user identification information;
creating an anonymous profile by filtering the user information;
ranking messages in a message database using best matching criteria from the anonymous profile to create a ranked list of messages;
selecting a targeted message from the ranked list of messages; and
transmitting the targeted message to the user.

14. A computer-implemented system for targeting messages and advertisements, the system comprising:
a user data storage device for storing data relevant to a user;
a processor having memory storing processor-executable instructions;
an account management device, wherein the account management device retrieves user information from the user data storage device;
an anonymous filter executed on the processor, wherein the anonymous filter communicates with the account management device and filters the user information retrieved from the user storage data device to create an anonymous profile;
a message storage device for storing messages for transmission to the user;
an anonymous message device, wherein the anonymous message device receives the anonymous profile from the anonymous filter and retrieves a targeted message from the message storage device; and
a user interface device for presenting the targeted message to the user, wherein the user interface device receives the targeted message from the anonymous message device.

15. The system of claim 14, wherein the anonymous profile comprises at least one of:
user age, user birth date, user year of birth, user gender, user income revenue, user average income, user location, user postal code, user marital status, user social class, or user level of education.

16. The system of claim 14, wherein the anonymous profile does not contain sensitive, personal, or nominative information on the user.

17. The system of claim 14, wherein the targeted message is one of:
an advertisement, a global message, a national message, a regional message, or a local message.

18. The system of claim 14, further comprising:
determining if more than one message is ranked highest in the ranked list of messages, wherein if more than one message is ranked highest in the ranked list of messages then randomly selecting the targeted message from one of the more than one message ranked highest in the ranked list.

19. A computer-implemented method for targeting messages and advertisements comprising:
receiving, by a computer, user identification information;
retrieving by the computer, user information based on the user identification information;
selecting by the computer, a targeted message from a message database; and
transmitting the targeted message from the computer.
